(19) United States
(12) Patent Application Publication
(10) Pub. No.: US 2015/0348093 A1
(43) Pub. Date: Dec. 3, 2015

(54) ADVERTISEMENT IMPRESSION INVENTORY MANAGER

(71) Applicant: Facebook, Inc., Menlo Park, CA (US)

(72) Inventors: Xiaohu Jiang, Palo Alto, CA (US); Yifei Zhang, Sunnyvale, CA (US); Bin Jiang, San Mateo, CA (US)

(73) Assignee: Facebook, Inc., Menlo Park, CA (US)

(21) Appl. No.: 14/288,154

(22) Filed: May 27, 2014

(51) Int. Cl. G06Q 30/02; G06Q 50/00

(52) U.S. Cl. CPC G06Q 30/0246; G06Q 50/01

(57) ABSTRACT

A social networking system determines a predicted supply of ad impressions over a future period of time for social networking system users based on past viewing information of advertisements presented to the users during a prior time period. Based on the predicted supply of ad impressions, the social networking system manages advertisement campaigns including ad requests received from advertisers. The social networking system determines whether the predicted supply of ad impressions is sufficient to satisfy criteria associated with an advertising campaign and provides feedback to an advertiser associated with the advertising campaign indicating whether the predicted supply of ad impressions contains sufficient unallocated expected ad impression opportunities to satisfy criteria associated with the advertising campaign.

### BACKGROUND

This disclosure relates generally to social networking systems, and more specifically to advertising via a social networking system.

Social networking systems, or social utilities that track and enable connections between users (including people, businesses, and other entities), have become prevalent in recent years and allow their users to more efficiently communicate information with other users. Users, such as advertisers, may advertise their brands, products, events, or otherwise communicate and disseminate advertising content to other users via a social networking system. For example, advertising content provided to a user may include information indicating other users' interactions with the advertising content, such as stories describing user interactions that may be included in a newsfeed presented to the user that describes interactions of other users.

Advertisers may provide a social networking system with monetary compensation in exchange for the social networking system presenting their advertising content to social networking system users. In conventional social networking systems, a social networking system selects an advertisement for presentation to a given user through an auction that ranks advertisements from various advertisers based at least in part on bid amounts associated with the advertisements. Thus, whether advertising content is presented to a user is based on a bid amount specified by an advertiser for the advertising content and bid amounts associated with other advertising content by other advertisers. However, conventional methods for advertising via social networking systems do not allow an advertiser to estimate a measure or number of the users that advertising content will successfully be able to reach based on a bid amount associated with the advertising content. Accordingly, conventional methods for advertising via a social networking system are unable to predict and manage an inventory of potential ad impressions for users over a future period of time based on objectives for advertisements specified by one or more advertisers.

### SUMMARY

A social networking system determines a predicted supply of advertisement (“ad”) impressions over a future period of time for users of the social networking system based on prior viewing information of the users that describes impressions of advertisements provided to the users during a previous period of time. The social networking system manages advertisement requests (“ad requests”) from one or more advertising campaigns based on the predicted supply of ad impressions. Different advertising campaigns may be associated with different advertisers. The social networking system determines whether the predicted supply of ad impressions is sufficient to satisfy one or more criteria associated with an advertising campaign. Based on this determination, the social networking system provides feedback to an advertiser associated with the advertising campaign indicating whether the predicted supply of ad impressions includes a number of expected ad impression opportunities not allocated for presenting advertisements that is sufficient to satisfy one or more criteria associated with the advertising campaign.

To predict the supply of ad impressions, the social networking system accesses past viewing information associated with a plurality of social networking system users describing impressions of advertisements provided to the plurality of users during a previous period of time. For example, the social networking system accesses past viewing information indicating a number of ad impressions for a user of the social networking system during each day for 30 days prior to a current date. Based on the past viewing information, the social networking system then predicts a supply of ad impressions for a future period of time. For example, the social networking system averages the number of ad impressions associated with a user that occurred on the same day of the week during a previous period of time (e.g., Mondays that occurred within the last 30 days), and use the averaged value as the predicted supply of ad impressions for that user for that day in the future period of time.

The social networking system updates the predicted supply of ad requests over the future period of time based on ad requests received from advertisers. Various ad requests may specify a desired number of ad impressions of advertisement content included in the ad request during the future period of time, allowing an advertiser to regulate distribution of the advertisement content of different ad requests. The social networking system allocates the number of ad impressions specified by the ad requests or specified by an advertising campaign to at least a portion of the predicted supply of ad impressions over the future period of time. For example, if a user or group of users is that is predicted to have three opportunities for ad impressions one day from the current day, the social networking system reduces the number of opportunities for ad impressions based on ad requests already allocated for presenting one or more advertisements or types of advertisements to the user or group of users on the day that is one day from the current day. For example, the social networking system may allocate two of the opportunities for ad impressions to the user for presenting certain types of advertisements, resulting in a single ad impression being available for allocation to an advertisement from other ad requests one day from the current day.

In some embodiments, the social networking system receives information specifying an advertising campaign from an advertiser. For example, the advertiser specifies criteria for an advertising request that includes a number of impressions of advertisements for advertisements in the advertising campaign. Based on the predicted supply of ad impressions during the future interval of time, the social networking system determines feedback indicating whether the predicted supply of ad impressions includes a sufficient number of unallocated expected ad impression opportunities to satisfy a number of impressions of advertisements in advertising campaign or to satisfy any other suitable criteria. If the predicted supply of ad impressions for a user during the future period of time is sufficient to satisfy the criteria of an advertising campaign (e.g., a number of impressions of advertisements from the advertising campaign), the social networking system reserves a number of ad impressions during the future period of time to the advertising campaign, updates the predicted supply of ad impressions that are not allocated to advertisements or advertising campaigns, and provides feedback to an advertiser associated with the advertising campaign that the number of ad impression opportunities associated with the advertising campaign has been reserved. However, if the predicted supply of ad impressions for a user during the future period of time that are not allocated is not sufficient to satisfy the criteria of the advertising campaign, the social networking system generates feedback indicating that the predicted supply of supply of ad impressions for the user is not sufficient to satisfy the criteria of the advertising campaign, and provides the feedback to the advertiser associated with the advertising campaign. Additionally, in some embodiments, the social networking system modifies one or more criteria associated with the advertising campaign and generates one or more alternative allocations satisfying the one or more modified one or more criteria of the advertising campaign and provides the one or more alternative allocations to an advertiser associated with the advertising campaign.

### BRIEF DESCRIPTION OF THE DRAWINGS

FIG. 1 is a block diagram of a system environment in which a social networking system operates, in accordance with an embodiment.

FIG. 2 is a block diagram of a social networking system, in accordance with an embodiment.

FIG. 3 is a flowchart illustrating a process for managing a predicted ad impression inventory for a future time period according to an embodiment.

FIG. 4 illustrates a table showing a predicted supply of impressions for advertisements over a future time period according to an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

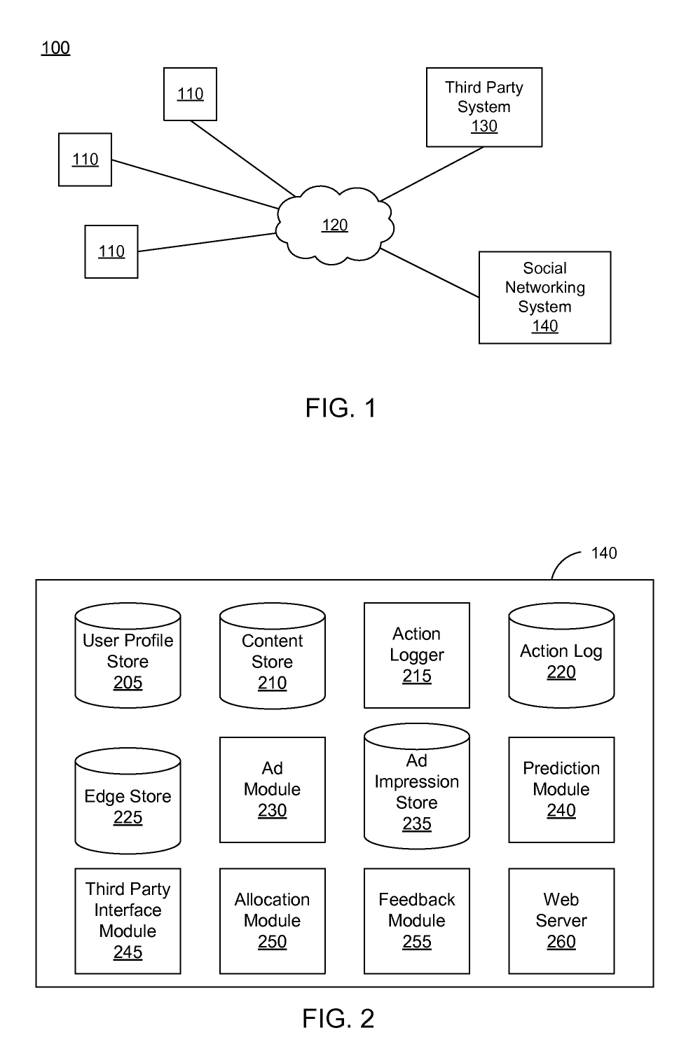

FIG. 1 is a high level block diagram of a system environment 100 for a social networking system 140. The system environment 100 shown by FIG. 1 comprises one or more client devices 110, a network 120, one or more third-party systems 130, and the social networking system 140. In alternative configurations, different and/or additional components may be included in the system environment 100. The embodiments described herein can be adapted to online systems that are not social networking systems.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the social networking system 140. For example, a client device 110 executes a browser application to enable interaction between the client device 110 and the social networking system 140 via the network 120. In another embodiment, a client device 110 interacts with the social networking system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

In some embodiments, a client device 110 includes instructions, such as program code, that when executed by the client device 110 communicates information describing presentation of advertisements to a user via the client device 110. For example, the program code is included in an application associated with the social networking system 140 executing on the client device 110 and communicates information describing presentation of advertisements via the application to a user of the social networking system 110 via the client device 110. The information communicated to the client device 110 identifies one or more impressions of advertisements to a user. An impression of an advertisement (also referred to herein as an “advertisement impression” or “ad impression”) occurs when the advertisement is presented by a client device 110. The instructions executed by the client device 110 determine if an advertisement was presented to a user based on interactions with the client device 110. For example, identification of an impression of an advertisement occurred is based on a percentage of the advertisement presented by the client device 110, a duration that a threshold amount of the advertisement is presented by the client device 110, or any other suitable information.

One or more third party systems 130 may be coupled to the network 120 for communicating with the social networking system 140, which is further described below in conjunction with FIG. 2. In one embodiment, a third party system 130 is an application provider communicating information describing applications for execution by a client device 110 or communicating data to client devices 110 for use by an application executing on the client device 110. In other embodiments, a third party system 130 provides content or other information for presentation via a client device 110. A third party system 130 may also communicate information to the social networking system 140, such as advertisements, content, or information about an application provided by the third party system 130. In some embodiments, the third party system 130 may be associated with one or more advertisers. For example, the third party system 130 may provide information relating to advertisers' advertising campaign to the social networking system 130.

FIG. 2 is a block diagram of an architecture of the social networking system 140. The social networking system 140 shown in FIG. 2 includes a user profile store 205, a content store 210, an action logger 215, an action log 220, an edge store 225, an ad module 230, an ad impression store 235, a prediction module 240, a third party interface module 245, an allocation module 250, a feedback module 255, and a web server 260. In other embodiments, the social networking system 140 may include additional, fewer, or different components for various applications. Conventional components such as network interfaces, security functions, load balancers, failover servers, management and network operations consoles, and the like are not shown so as to not obscure the details of the system architecture.

Each user of the social networking system 140 is associated with a user profile, which is stored in the user profile store 205. A user profile includes declarative information about the user that was explicitly shared by the user and may also include profile information inferred by the social networking system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system 140 displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the social networking system 140, user profiles may also be stored for entities such as businesses or organizations. This allows an entity to establish a presence on the social networking system 140 for connecting and exchanging content with other social networking system users. The entity may post information about itself, about its products or provide other information to users of the social networking system using a brand page associated with the entity's user profile. Other users of the social networking system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Social networking system users may create objects stored by the content store 210, such as status updates, photos tagged by users to be associated with other objects in the social networking system, events, groups or applications. In some embodiments, objects are received from third-party applications or third-party applications separate from the social networking system 140. In one embodiment, objects in the content store 210 represent single pieces of content, or content “items.” Hence, social networking system users are encouraged to communicate with each other by posting text and content items of various types of media to the social networking system 140 through various communication channels. This increases the amount of interaction of users with each other and increases the frequency with which users interact within the social networking system 140.

One or more advertisement requests (“ad requests”) are included in the content store 210. An advertisement request includes advertisement content and a bid amount. Additionally, in some embodiments, the advertisement request may include criteria (e.g., number of ad impressions) from an associated advertisement campaign (discussed below with regard to the ad module 230). The advertisement content is text, image, audio, video, or any other suitable data presented to a user. In various embodiments, the advertisement content also includes a landing page specifying a network address to which a user is directed when the advertisement is accessed. The bid amount is associated with an advertisement by an advertiser and is used to determine an expected value, such as monetary compensation, provided by an advertiser to the social networking system 140 if the advertisement is presented to a user, if the advertisement receives a user interaction, or based on any other suitable condition. For example, the bid amount specifies a monetary amount that the social networking system 140 receives from the advertiser if the advertisement is displayed and the expected value is determined by multiplying the bid amount by a probability of the advertisement being accessed.

Additionally, an advertisement request may include one or more targeting criteria specified by the advertiser. Targeting criteria included in an advertisement request specify one or more characteristics of users eligible to be presented with advertisement content in the advertisement request. For example, targeting criteria are used to identify users having user profile information, edges or actions satisfying at least one of the targeting criteria. Hence, targeting criteria allow an advertiser to identify users having specific characteristics, simplifying subsequent distribution of content to different users.

In one embodiment, targeting criteria may specify actions or types of connections between a user and another user or object of the social networking system 140. Targeting criteria may also specify interactions between a user and objects performed external to the social networking system 140, such as on a third party system 130. For example, targeting criteria identifies users that have taken a particular action, such as sending a message to another user, using an application, joining a group, leaving a group, joining an event, generating an event description, purchasing or reviewing a product or service using an online marketplace, requesting information from a third-party system 130, or any other suitable action. Including actions in targeting criteria allows advertisers to further refine users eligible to be presented with content from an advertisement request. As another example, targeting criteria identifies users having a connection to another user or object or having a particular type of connection to another user or object.

The action logger 215 receives communications about user actions internal to and/or external to the social networking system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the social networking system 140 to track user actions on the social networking system 140, as well as actions on third party systems 130 that communicate information to the social networking system 140. Users may interact with various objects on the social networking system 140, and information describing these interactions is stored in the action log 210. Examples of interactions with objects include: commenting on posts, sharing links, and checking-in to physical locations via a mobile device, accessing content items, and any other suitable interactions. Additional examples of interactions with objects on the social networking system 140 that are included in the action log 220 include: commenting on a photo album, communicating with a user, establishing a connection with an object, joining an event, joining a group, creating an event, authorizing an application, using an application, expressing a preference for an object (“liking” the object) and engaging in a transaction. Additionally, the action log 220 may record a user's interactions with advertisements on the social networking system 140 as well as with other applications operating on the social networking system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the social networking system 140. For example, an e-commerce website may recognize a user of a social networking system 140 through a social plug-in enabling the e-commerce website to identify the user of the social networking system 140. Because users of the social networking system 140 are uniquely identifiable, e-commerce websites, such as in the preceding example, may communicate information about a user's actions outside of the social networking system 140 to the social networking system 140 for association with the user. Hence, the action log 220 may record information about actions users perform on a third party system 130, including webpage viewing histories, advertisements that were engaged, purchases made, and other patterns from shopping and buying.

In one embodiment, the edge store 225 stores information describing connections between users and other objects on the social networking system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 140, such as expressing interest in a page on the social networking system 140, sharing a link with other users of the social networking system 140, and commenting on posts made by other users of the social networking system 140.

In one embodiment, an edge may include various features each representing characteristics of interactions between users, interactions between users and object, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the social networking system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the social networking system 140 over time to approximate a user's interest in an object, a topic, or another user in the social networking system 140 based on the actions performed by the user. A user's affinity may be computed by the social networking system 140 over time to approximate a user's interest in an object, a topic, or another user in the social networking system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The ad module 230 stores information describing advertising campaigns received from one or more advertisers. An advertising campaign is associated with an advertiser and includes one or more ad requests. For example, an advertising campaign includes multiple ad requests including advertisement content relating to a specific product or service.

Additionally, an advertising campaign may be associated with criteria, such as one or more objectives, a duration, and a budget. An objective associated with an advertising campaign describes one or more goals for actions associated with the advertising campaign. For example, an objective specifies a total number of impressions of advertisements in the advertising campaign to social networking system users (an “impression objective”) during a specified time interval, specifies a total number of unique social networking system users to be presented with at least one advertisement from the advertising campaign (a “reach objective”), a number of times an advertisement from the advertising campaign is presented to a social networking system user (a “frequency objective”), or any other suitable criteria. The budget specifies a total amount of compensation an advertiser associated with an advertising campaign provides the social networking system 140 for presenting advertisements in the advertising campaign or for the social networking system 140 receiving interactions with advertisements in the advertising campaign. Additionally, the duration associated with the advertising campaign specifies a time interval during which advertisements from the advertising campaign are presented to social networking system users. For example, if the duration of an advertising campaign is 30 days, advertisements included in the advertising campaign are presented to social networking system users for 30 days after the advertising campaign is provided to the social networking system 140. In some embodiments, the advertiser may also specify a start date for the advertising campaign, so the duration is measured from the specified start date.

An advertising campaign includes one or more ad requests that each describe advertisements in the advertising campaign for presentation to one or more social networking system users. As described above, an ad request may include a bid amount. In alternate embodiments, the advertiser does not associate a bid amount with the ad request, but the social networking system 140 determines a bid amount for the ad request based on a budget, a duration, and/or an objective associated with the advertising campaign including the ad request. For example, based on a reach objective, a bid amount that would accomplish the reach objective may be determined by the social networking system 140. Determination of bid amounts for ad requests included in an advertising campaign based on a budget, a duration, or an objective associated with the advertising campaign is further described in U.S. patent application Ser. No. 14/164,086, filed on Jan. 24, 2014, which is hereby incorporated by reference in its entirety.

The ad impression store 235 includes past viewing information describing advertisements previously selected for presentation to users and provided to client devices 110 for presentation to users. For example, the past viewing information includes information identifying an advertisement associated with an ad request that was selected for presentation to a user (e.g., an advertisement corresponding to an ad request selected via a previously completed advertisement auction), a bid amount associated with the selected ad request, an amount charged to an advertiser associated with the selected ad request, targeting criteria associated with the selected ad request, a context scalar describing user characteristics and other context in which the selected ad request was presented, an indicator whether content from the selected ad request was presented to the user, or any other suitable information.

The prediction module 240 retrieves past viewing information associated with one or more users of the social networking system 140 over a prior time period. For example, the prediction module 240 retrieves past viewing information associated with multiple social networking system users over a two week interval, over a month interval, or over any suitable time interval. In some embodiments, the prediction module 240 accounts for characteristics of users when retrieving past viewing information, allowing the prediction module 240 to retrieve past viewing information associated with a subset of users having specified characteristics. For example, the prediction module 240 retrieves past viewing information for users indicating a specific current location. Alternatively, the prediction module 240 may retrieve past viewing information associated with all of the users of the social networking system 140.

Based on the retrieved past viewing information, the prediction module 240 predicts a supply of impressions of advertisements during a future period of time. The future time period may be a time period based on a current time (e.g., a number of days from a current day) or may be based on a specified date or time. In some embodiments, the prediction module 240 analyzes the retrieved viewing information using one or more prediction algorithms. A prediction algorithm is an algorithm that predicts a supply of impressions of advertisements for user (or group of users) of the social networking system 140 over some future period of time (e.g., the next week, the next 10 days, the next month, etc.) based on characteristics of advertisements previously presented to the user, user interaction with the social networking system 140, characteristics of the user, or any other suitable information. In some embodiments, the prediction algorithm averages a number of impressions that occur within a repeating subinterval (e.g., morning, day of the week, week, etc.) during a prior time period, and identifies an average number of impressions during each subinterval(rounded to integers) as a predicted number of ad impressions during a length of time corresponding to the length of a subinterval in the future time period. For example, the prediction algorithm averages a number of impressions occurring during various days of the week for at least a portion of the prior time period, and then set the averaged values (rounded to integers) as the predicted number of ad impressions for corresponding days of the week in the future time period. As an example, the past viewing information for a particular user indicates that a single advertisement was presented to the user on Mondays, Tuesdays, Wednesdays, Thursdays and Fridays over the past month, four advertisements were presented to the user on Saturdays during the past month, and three advertisements were presented to the user during the past month. In this example, based on the past viewing information and for a future time period of a week, the prediction module 240 predicts a supply of a single ad impression for the user on Monday, Tuesday, Wednesday, Thursday, and Friday during an upcoming week, a supply of four ad impressions for the user on Saturday during the upcoming week, and a supply of three ad impressions for the user on Sunday during the upcoming week.

The third party interface module 245 receives information from an advertiser describing an advertising campaign or describing one or more ad requests. Example information associated with an advertising campaign includes one or more objectives (e.g., frequency objective, reach objective, and/or impression objective), budgets, durations, or some combination thereof that are associated with one or more advertising campaigns. An advertiser may prioritize one or more objectives of an advertising campaign or may prioritize a budget or a duration associated with the advertising campaign when communicating information describing the advertising campaign to the third party interface module 245. As further discussed below, the prioritization of an objective, a budget, or a duration may be used to suggest modifications to an advertisement campaign if one or more of its criteria (e.g., budget) are unable to be satisfied based on the predicted supply of ad impressions during the future period of time. The third party interface module 245 communicates received information describing an advertising campaign to the ad module 230 for storage.

The allocation module 250 allocates impressions of advertisements from at least a portion of a predicted supply of impressions of advertisements to one or more advertising campaigns. In one embodiment, the allocation module 250 identifies ad requests from the advertising campaign, where various ad requests specify a number of impressions of advertisements. The allocation module 250 may combine the number of impressions identified by the various ad requests to determine a total number of advertisement impressions to allocate to the advertising campaign. In one embodiment, the allocation module 250 allocates a number of impressions from the predicted supply of impressions of advertisements to an ad request based on the number of impressions identified by the ad request. The allocation module 250 may also allocate a number of impressions from the predicted supply of impressions to an advertising campaign based on a total number of advertising impressions for the advertising campaign. For example, an objective of an ad campaign is to have an impression of content from an ad request included in the ad campaign each day during a future time period (e.g., next seven days). The allocation module 250 determines the number of available opportunities for an impression of an advertisement on each day during the future time period, and allocates an impression from the predicted supply of impressions of an advertisement determined for each day of the future time period that are not previously allocated to an advertising campaign to the advertising campaign. After allocating impressions from the predicted opportunities for an impression of an advertisement during the future period of time to an ad request or to an advertising campaign, the allocation module 250 updates the predicted supply of impressions of advertisements during the future period of time to account for the allocation (e.g., subtracts the number of impressions allocated from the predicted supply of impressions of advertisements during the future period of time).

When allocating a specified number of impressions of an ad request or of an advertisement campaign, the allocation module 250 accounts for one or more criteria associated with the advertising campaign or with an advertising campaign including the ad request. The allocation module 250 attempts to identify one or more potential allocations of impressions among various users of the social networking system 140 during the future period of time that satisfy criteria associated with an advertising campaign. If a threshold number of the criteria associated with an advertising campaign (e.g., all of the criteria) are satisfied when allocating impressions from the predicted supply of impressions during the future period of time, the allocation module 250 allocates opportunities for impressions of advertisements from the predicted supply to the advertising campaign, and notifies the feedback module 255 that the opportunities for impressions of advertisements from the predicted supply of impression during the future period of time have been successfully allocated to the advertising campaign according to the criteria of the advertising campaign. However, if one or more of the criteria are not satisfied when allocating impressions from the predicted supply to the advertising campaign, the allocation module 250 identifies an error and notifies the feedback module 255 of the error. In some embodiments, if an error is identified the allocation module 250 attempts to generate one or more alternate allocations of opportunities for impressions of advertisements during the future period of time to the advertising campaign that satisfy criteria associated with the advertising campaign. For example, the allocation module 250 may adjust one or more of the objectives, the budget, the duration, or some combination thereof until all of the criteria is satisfied. In some embodiments, the allocation module 250 adjusts one or more of the advertising campaign criteria based on priorities associated with different criteria. For example, the allocation module 250 initially adjusts criteria associated with a lowest priority.

The feedback module 255 determines feedback for presentation to an advertiser based on whether criteria of an advertising campaign associated with the advertiser are satisfied based on the predicted number of impressions of advertisements during the future period of time. If the feedback module 255 receives an indication that the opportunities for impressions of advertisements from an advertising campaign have been successfully reserved from the predicted impressions of advertisements during the future time period so that criteria of an advertising campaign are satisfied, the feedback module 255 communicates a message to an advertiser associated with the advertising campaign that the opportunities for impressions of advertisements from the advertising campaign have been successfully allocated from the predicted impressions of advertisements during the future time period. In some embodiments, the message communicated to the advertiser requests that the advertiser finalize the allocation by compensating the social networking system 140 or performing another suitable action. In some embodiments, the feedback module 255 communicates with the allocation module 250 to remove the allocation of impressions of advertisements from the predicted impressions of advertisements during the future time period if the advertiser does not finalize the allocation within a threshold time (e.g., 10 minutes) of receiving the message that impression from the predicted impressions of advertisements were successfully allocated to the advertising campaign or if the advertiser rejects the allocation. If confirmation of the allocation is received, the feedback module 255 confirms the allocation of opportunities for impressions of advertisements to the allocation module 250. In alternate embodiments, if the feedback module 255 receives an indication that the opportunities for impressions of advertisements have been successfully allocated from the predicted impressions of advertisements in the future time period so the criteria of an advertising campaign are satisfied, the feedback module 255 automatically finalizes the allocation and notifies an advertiser associated with the advertising campaign.

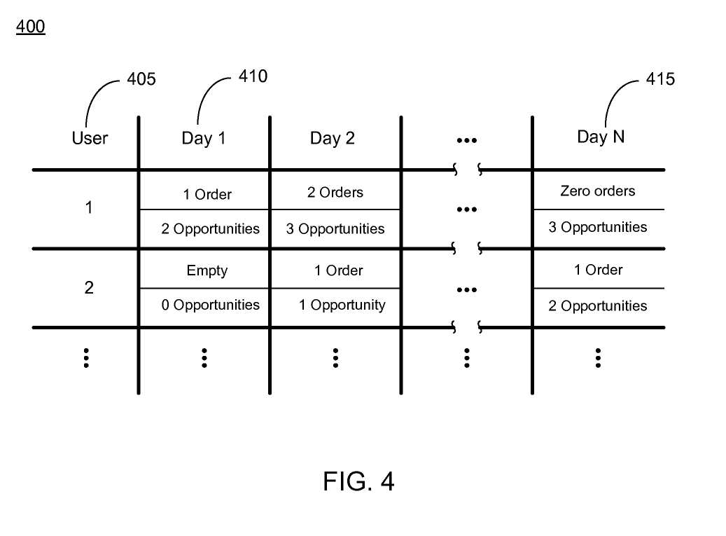

In some embodiments, the feedback module 255 may generate information, such as a table (further described below in conjunction with FIG. 4), presented to an advertiser or to another third party identifying a predicted supply of impressions of advertisements over a future time period for users of the social networking system 140. The feedback module 255 may present the table to the advertiser to facilitate development of the advertiser's advertising campaign. Alternatively, information summarizing the predicted supply of impressions of advertisements during the future time period, which may identify a number of the predicted supply of impressions already allocated to advertising campaigns or to ad requests, is communicated to the advertiser or to the third party.

The web server 260 links the social networking system 140 via the network 120 to the one or more client devices 110, as well as to the one or more third party systems 130. The web server 260 serves web pages, as well as other web-related content, such as JAVA®, FLASH®, XML and so forth. The web server 260 may receive and route messages between the social networking system 140 and the client device 110, for example, instant messages, queued messages (e.g., email), text messages, short message service (SMS) messages, or messages sent using any other suitable messaging technique. A user may send a request to the web server 260 to upload information (e.g., images or videos) that are stored in the content store 210. Additionally, the web server 260 may provide application programming interface (API) functionality to send data directly to native client device operating systems, such as IOS®, ANDROID™, WEBOS® or BlackberryOS.

### Ad Impression Inventory Management

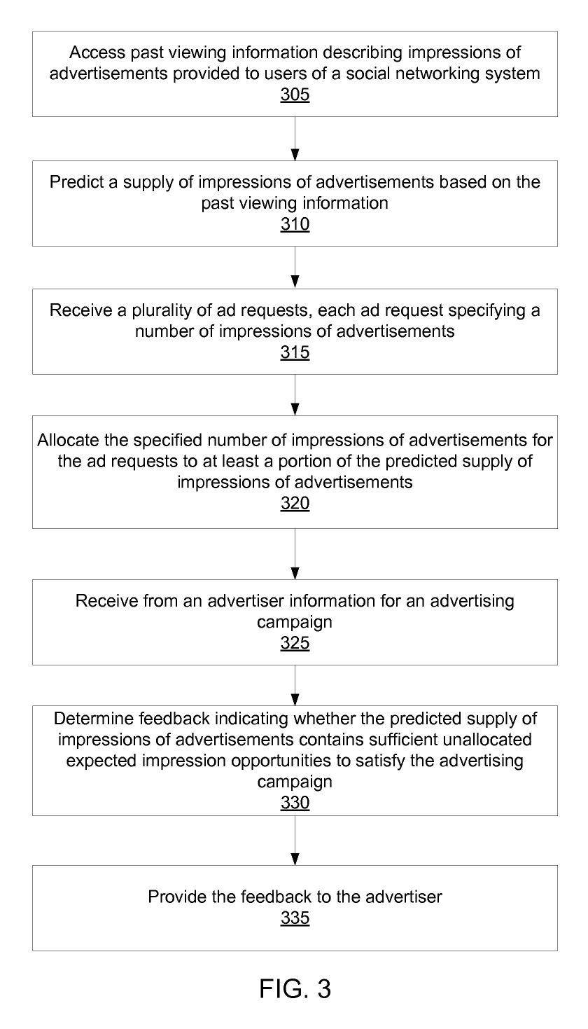

FIG. 3 is a flowchart of an embodiment of a process for managing a predicted inventory of ad impressions for a future time period. In one embodiment, the process of FIG. 3 is performed by the social networking system 140. However, in other embodiments, other entities may perform some or all of the steps of the process. Likewise, embodiments may include different and/or additional steps, or perform the steps in different orders.

The social networking system 140 accesses 305 past viewing information describing impressions of advertisements previously provided to social networking system users during a prior time period (e.g., the last 30 days). In some embodiments, the social networking system 140 accesses 305 past viewing information to identify a specified number of impressions of advertisements during the prior time period. Additionally, the social networking system 140 may access 305 past viewing information describing impressions of advertisements associated with a subset of users, such as users having one or more specified characteristics, during the prior time period or may access 305 past viewing information describing impressions of advertisements to all social networking system users during the prior time period.

Based on the past viewing information, the social networking system 140 predicts 310 a supply of impressions of advertisements during a future time period. For example, the social networking system 140 applies one or more prediction algorithms to the past viewing information to predict 310 a supply of impressions of advertisements to users of the social networking system over a future time period. In some embodiments, a predication algorithm averages the numbers of impressions of advertisements that occurred during various intervals of the prior time period (e.g., during days of a week or during days of a month). For example, the social networking system 140 averages a number of impressions of advertisements that occurred on Mondays (or some other day of the week) over the prior time period, and use the average value as the predicted number of opportunities for impressions of advertisements on Mondays within the future time period. Thus, the social networking system 140 predicts 310 a predicted supply of opportunities for impressions of advertisements for a future time period based on the past viewing information describing impressions of advertisements provided to social networking system users during the prior time period.

The social networking system 140 receives 315 a plurality of ad requests from advertisers, with each ad request specifying a number of impressions of advertisements. For example, the social networking system 140 receives 315 an advertising campaign including a plurality of ad requests with a number of impressions associated with the advertising campaign. The social networking system 140 may also receive one or more objectives associated with an advertising campaign as well as a prioritization associated with one or more of the objectives (e.g., reach objective, frequency objective, and/or impression objective), with a budget, with a duration, or with other parameters of the advertising campaign.

In some embodiments, the social networking system 140 generates information describing the predicted supply of impressions of advertisements over the future time period. For example, the social networking system 140 generates a table 400 describing a predicted supply of impressions during a future period of time as shown in FIG. 4. In the example of FIG. 4, the future time period is divided into days, running from Day 1 410 to Day N 415, where N is an integer value. In this embodiment, the table identifies groups 405 of users (e.g., User 1, User 2, etc.) where each group includes one or more users. The table 400 shown in FIG. 4 illustrates a predicted supply of impressions for advertisements (i.e., total number of opportunities to present an advertisement) on a given day and a number impressions allocated to an ad request or to an advertising campaign for the given day for each group 405 of users. In FIG. 4, an “order” indicates a number of opportunities for impressions currently allocated to an advertising campaign or to an ad request. For example, in FIG. 4, during Day 1, User 1 has a predicted supply of 2 impressions of advertisements, with one impression currently allocated to an advertising campaign or to an ad request, so there is a single opportunity for an advertisement impression available for allocation to an advertising campaign or to an advertising request during Day 1 (i.e., 2 opportunities−1 order=1). In contrast, in the example of FIG. 4, there are no available opportunities for impressions of advertisements for User 2 on Day 2 for allocation as the single predicted opportunity for an impression is allocated to an advertising campaign or to an advertisement request. In alternate embodiments, the table 400 identifies a supply of predicted impressions of advertisements over a future time period, but not a number of predicted impressions currently allocated to an advertising campaign or to an advertisement request. Hence, the number of advertisement opportunities available for allocation would be presented. In such an embodiment, the table 400 in FIG. 4 would identify one opportunity for an advertisement impression available for allocation for User 1 on Day 1.

Turning back to FIG. 3, the social networking system 140 allocates 320 a number of the predicted impressions of advertisements during the future time period to the received ad requests based on the number of impressions specified by the received ad requests. This allocates 320 at least a portion of the predicted supply of impressions of advertisements during the future time period to the received ad requests. When allocating 320 the portion or portions of the predicted supply of impressions of advertisements during the future time period, the social networking system 140 may account for criteria associated with the ad requests or associated with an advertising campaign including the ad requests.

The social networking system 140 receives 325 information for an advertising campaign from an advertiser. The information identifies one or more ad requests included in the advertising campaign and a number of impressions for advertisements described by ad requests included in the advertising campaign. Additionally, the information may specify one or more additional criteria associated with the advertising campaign, such as a frequency objective, a budget, or a reach objective. Based on the information for the advertising campaign, the social networking system 140 determines if a number of predicted impressions of advertisements during the future period of time is sufficient to satisfy the advertising campaign. For example, the social networking system 140 determines if a number of predicted impressions of advertisements unallocated to ad requests or additional advertising campaigns is sufficient to satisfy a number of impressions identified by the received information for the advertising campaign. Hence, the social networking system 140 determines if the number of impressions for advertisement during the future period of time available for allocation to the advertising campaign is sufficient to satisfy criteria associated with the advertising campaign, such as a number of impressions of advertisements from the advertising campaign during the future period of time.

Based on whether the predicted supply of impressions of advertisements during the future period of time includes a sufficient number of impressions to satisfy criteria of the advertising campaign, the social networking system 140 determines 330 feedback indicating whether the advertising campaign may be satisfied based on the predicted supply of impressions during the future period of time. If the predicted supply of impressions during the future period of time is sufficient to satisfy at least a threshold number of criteria associated with the advertising campaign, or to satisfy all of the criteria associated with the advertising campaign, the social networking system 140 determines 330 feedback indicating that the predicted supply of impressions of advertisements contains sufficient unallocated expected impression opportunities to satisfy the advertising campaign. In some embodiments, the social networking system 140 allocates opportunities for impressions during the future time period to the advertisement campaign if the predicted supply of impressions of advertisements contains sufficient unallocated expected impression opportunities to satisfy criteria associated with the advertising campaign.

However, if one or more of the criteria of the advertising campaign are not satisfied based on the number of unallocated impressions for advertisements during the future time period, the social networking system 140 determines 330 feedback notifying the advertiser associated with the advertising campaign that the supply of predicted opportunities for impressions of advertisements during the future time period is not sufficient to satisfy the criteria of the advertising campaign. For example, the social networking system 140 may generate a message for the requesting advertiser that includes the determined feedback. In some embodiments, the social networking system 140 identifies one or more alternate criteria for the advertising campaign so the alternate criteria are satisfied by one or more allocations of opportunities for impressions of advertisements during the future time period. For example, the social networking system 140 may modify one or more of the objectives, the budget, the duration, or some combination so at least a threshold number of criteria are satisfied by allocating advertisements from the advertising campaign to opportunities for impressions of advertisements during the future time period. The social networking system 140 may modify one or more of the advertising campaign criteria based on priorities associated with the criteria (e.g., initially modify the criteria with the lowest priority). The determined feedback may identify one or more of the modifications to the criteria associated with the advertising campaign. The social networking system then provides 335 the feedback to the advertiser. In some embodiments, the feedback may include a table, such as shown in FIG. 4.

### Summary

The foregoing description of the embodiments has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
accessing past viewing information associated with a plurality of users of a social networking system, the past viewing information describing impressions of advertisements provided to the plurality of users during a prior period of time;
predicting, for a future period of time, a supply of impressions of advertisements based on the past viewing information, wherein the supply of impressions of advertisements comprises a plurality of expected impression opportunities to provide an advertisement to a user of the plurality of users during the future period of time;
receiving a plurality of ad requests, each ad request specifying a number of impressions of advertisements to be delivered during the future period of time;
allocating the specified number of impressions of advertisements for the ad requests to at least a portion of the predicted supply of impressions of advertisements;
receiving from an advertiser information for an advertising campaign, the advertising campaign specifying criteria comprising a number of impressions of advertisements;
determining feedback indicating whether the predicted supply of impressions of advertisements contains sufficient unallocated expected impression opportunities to satisfy the criteria specified by the advertising campaign; and
providing the feedback to the advertiser.

2. The method of claim 1, wherein predicting, for the future period of time, the supply of impressions of advertisements based on the past viewing information, comprises:
determining one or more numbers of impressions of advertisements that occurred during the previous period of time based at least in part on the past viewing information; and
analyzing, for each user from the plurality of users, the one or more numbers of impressions of advertisements that occurred using a predictive algorithm to predict a supply of impressions of advertisements available for a portion of the future period of time.

3. The method of claim 2, wherein analyzing, for each user from the plurality of users, the one or more numbers of impressions of advertisements that occurred using the predictive algorithm to predict a supply of impressions of advertisements available for the portion of the future period of time comprises:
averaging, for each user from the plurality of users, the numbers of impressions of advertisements that occurred within an interval of the prior period of time; and
setting, for each user, the predicted supply of impressions for advertisements for an interval of the future time period having a same duration as the interval of the prior period of time based at least in part on the averaged numbers of impressions of advertisements that occurred within the interval of the prior period of time.

4. The method of claim 1, wherein allocating the specified number of impressions of advertisements for the ad requests to at least the portion of the predicted supply of impressions of advertisements comprises:
reducing the predicted supply of impressions for advertisements based on the specified number of impressions of advertisements.

5. The method of claim 1, wherein determining feedback indicating whether the predicted supply of impressions of advertisements contains sufficient unallocated expected impression opportunities to satisfy the criteria specified by the advertising campaign comprises:
generating a message indicating the predicted supply of impressions of advertisement does not include sufficient unallocated expected impression opportunities to satisfy the criteria specified by the advertising campaign if a number of unallocated expected impression opportunities included in the predicted supply of impressions of advertisements is less than the number of impressions of advertisements.

6. The method of claim 1, wherein determining feedback indicating whether the predicted supply of impressions of advertisements contains sufficient unallocated expected impression opportunities to satisfy the criteria specified by the advertising campaign comprises:
determining one or more modifications to the criteria based at least in part on a number of unallocated expected impression opportunities included in the predicted supply of impressions; and
generating feedback identifying the one or more modifications to the criteria.

7. The method of claim 1, wherein the determined feedback includes information describing a predicted supply of impressions of advertisements for one or more users of the social networking system during the future period of time.

8. A computer program product comprising a computer-readable storage medium having instructions encoded thereon that, when executed by a processor, cause the processor to:
access past viewing information associated with a plurality of users of a social networking system, the past viewing information describing impressions of advertisements provided to the plurality of users during a prior period of time;
predict, for a future period of time, a supply of impressions of advertisements based on the past viewing information, wherein the supply of impressions of advertisements comprises a plurality of expected impression opportunities to provide an advertisement to a user of the plurality of users during the future period of time;
receive a plurality of ad requests, each ad request specifying a number of impressions of advertisements to be delivered during the future period of time;
allocate the specified number of impressions of advertisements for the ad requests to at least a portion of the predicted supply of impressions of advertisements;
receive from an advertiser information for an advertising campaign, the advertising campaign specifying criteria comprising a number of impressions of advertisements;
determine feedback indicating whether the predicted supply of impressions of advertisements contains sufficient unallocated expected impression opportunities to satisfy the criteria specified by the advertising campaign; and
provide the feedback to the advertiser.

9. The computer program product of claim 8, wherein predict, for the future period of time, the supply of impressions of advertisements based on the past viewing information, comprises:
determine one or more numbers of impressions of advertisements that occurred during the previous period of time based at least in part on the past viewing information; and
analyze, for each user from the plurality of users, the one or more numbers of impressions of advertisements that occurred using a predictive algorithm to predict a supply of impressions of advertisements available for a portion of the future period of time.

10. The computer program product of claim 9, wherein analyze, for each user from the plurality of users, the one or more numbers of impressions of advertisements that occurred using the predictive algorithm to predict a supply of impressions of advertisements available for the portion of the future period of time comprises:
average, for each user from the plurality of users, the numbers of impressions of advertisements that occurred within an interval of the prior period of time; and
set, for each user, the predicted supply of impressions for advertisements for an interval of the future time period having a same duration as the interval of the prior period of time based at least in part on the averaged numbers of impressions of advertisements that occurred within the interval of the prior period of time.

11. The computer program product of claim 8, wherein allocate the specified number of impressions of advertisements for the ad requests to at least the portion of the predicted supply of impressions of advertisements comprises:
reduce the predicted supply of impressions for advertisements based on the specified number of impressions of advertisements.

12. The computer program product of claim 8, wherein determine feedback indicating whether the predicted supply of impressions of advertisements contains sufficient unallocated expected impression opportunities to satisfy the criteria specified by the advertising campaign comprises:
generate a message indicating the predicted supply of impressions of advertisement does not include sufficient unallocated expected impression opportunities to satisfy the criteria specified by the advertising campaign if a number of unallocated expected impression opportunities included in the predicted supply of impressions of advertisements is less than the number of impressions of advertisements.

13. The computer program product of claim 8, wherein determine feedback indicating whether the predicted supply of impressions of advertisements contains sufficient unallocated expected impression opportunities to satisfy the criteria specified by the advertising campaign comprises:
determine a message indicating the predicted supply of impressions of advertisement does not include sufficient unallocated expected impression opportunities to satisfy the criteria specified by the advertising campaign if a number of unallocated expected impression opportunities included in the predicted supply of impressions of advertisements is less than the number of impressions of advertisements.

14. The computer program product of claim 8, wherein determine feedback indicating whether the predicted supply of impressions of advertisements contains sufficient unallocated expected impression opportunities to satisfy the criteria specified by the advertising campaign comprises:
determine one or more modifications to the criteria based at least in part on a number of unallocated expected impression opportunities included in the predicted supply of impressions; and
generate feedback identifying the one or more modifications to the criteria.

15. The computer program product of claim 8, wherein the determined feedback includes information describing a predicted supply of impressions of advertisements for one or more users of the social networking system during the future period of time.

16. The computer program product of claim 15, wherein the information describing the predicted supply of impressions of advertisements for one or more users identifies a predicted supply of unallocated impression of advertisements for one or more users during various time intervals of the future period of time.

17. A method comprising:
predicting, for a future period of time, a supply of impressions of advertisements based on information describing impressions of advertisements provided to a plurality of users of a social networking system during a prior period of time, the supply of impressions of advertisements comprises a plurality of expected impression opportunities to provide an advertisement to a user of the plurality of users during the future period of time;
receiving from an advertiser information for an advertising campaign, the advertising campaign specifying criteria comprising a number of impressions of advertisements;
determining feedback indicating whether the predicted supply of impressions of advertisements contains a number of expected impression opportunities sufficient to satisfy the criteria specified by advertising campaign; and
providing the feedback to the advertiser.

18. The method of claim 17, wherein predicting, for the future period of time, the supply of impressions of advertisements based on information describing impressions of advertisements provided to a plurality of users of a social networking system during a prior period of time comprises:
receiving a plurality of ad requests, each ad request specifying a number of impressions of advertisements to be delivered during the future period of time;
allocating the specified number of impressions of advertisements for the ad requests to at least a portion of the predicted supply of impressions of advertisements; and
identifying a number of impressions of advertisements from the predicted supply of impressions of advertisements not allocated to the specified number of advertisements.

19. The method of claim 18, wherein determining feedback indicating whether the predicted supply of impressions of advertisements contains the number of expected impression opportunities sufficient to satisfy the advertising campaign comprises:
determining whether the identified number of impressions of advertisements from the predicted supply of impressions is sufficient to satisfy the criteria specified by the advertising campaign; and
determining the feedback based at least in part on the determination.

20. The method of claim 18, wherein determining feedback indicating whether the predicted supply of impressions of advertisements contains a number of expected impression opportunities sufficient to satisfy the criteria specified by advertising campaign comprises:
determining one or more modifications to the criteria based at least in part on the predicted supply of impressions; and
generating feedback identifying the one or more modifications to the criteria.
